(19) United States
(12) Patent Application Publication
(10) Pub. No.: US 2009/0245952 A1
(43) Pub. Date: Oct. 1, 2009

(54) BIT WITH A CUSHION CORE

(76) Inventors: Leslie Banduch, Libertyville, IL (US); William J. Kochan, Schaumburg, IL (US); Brenan Guy, Lake Villa, IL (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/059,248

(22) Filed: Mar. 31, 2008

(51) Int. Cl. B23B 27/18; B26D 1/12

(52) U.S. Cl. 407/54; 407/118; 408/144

(57) ABSTRACT

A bit includes a body, a cutting edge, and a shim. The body has a shank end and a cutting end, and the shank end is arranged to be held by a drill or router. The cutting edge is positioned at the cutting end of the body. The shim is between the cutting end of the body and the cutting edge, and the shim is arranged to absorb forces so as to protect the cutting edge.

### TECHNICAL FIELD

The present disclosure relates to bits such as those used with drills or routers to process abrasive materials. In the case of a routers, the bit disclosed herein can be used, for example, with portable or stationary routers to form edges, cutouts, or holes in abrasive materials.

### BACKGROUND

Bits are commonly employed for forming holes in wood and other similar cutting resistant materials. Such bits frequently include an elongated steel shank or shaft with one end formed for removable attachment to a drill or router. The opposite end is formed with a cutting edge typically having a centering tip and a pair of spur tips on opposite sides of the centering tip. During operation, the centering tip centers the bit, and the spur tips cut the material as the hole is being formed.

Router bits are commonly employed for forming smooth edges, or cutouts in wood and other similar cutting resistant materials. Such bits frequently include an elongated steel shank or shaft with one end formed for attachment to a router. The opposite end is formed with a cutting edge, or edges, that are primarily used for side cutting or edge forming but also for center cutting by plunging through material. During operation, the bit can be plunged through the material to begin an edge cutting operation, or can enter from the outside of the material and begin an edge cutting operation.

While such a bit adequately trims or cuts woods and other relatively soft materials, problems occur when these bits are used to cut harder and more abrasive materials such as particle board, MDF, plywood, double sided melamine, and other laminate materials. The abrasiveness of these materials easily dulls the cutting edges of known bits. Moreover, the heat generated by the friction between the material being cut and the bit reduces the cutting capability of the bit cutting edges.

Solid carbide or carbide tipped bits are often employed to cut into these hard composites and more abrasive materials. However, there is limit to the hardness of the carbide used in these bits because harder carbide is more fragile and can be damaged or break due to the friction and vibration generated during operation and due to the force required to cut through hard composites and more abrasive materials.

The composite bit disclosed herein overcomes one or more of these or other problems.

### BRIEF DESCRIPTION OF THE DRAWING

Features and advantages of the composite bit disclosed herein will become more apparent from the following detailed description when taken in conjunction with the drawing in which:

FIG. 1 is an isometric view of the composite bit disclosed herein;

FIG. 2 is a side view of a bit body used for the composite bit of FIG. 1;

FIG. 3 is a side view of the composite bit of FIG. 1; and,

FIG. 4 is an end view of the cutting tip of the composite bit of FIG. 1.

### DETAILED DESCRIPTION

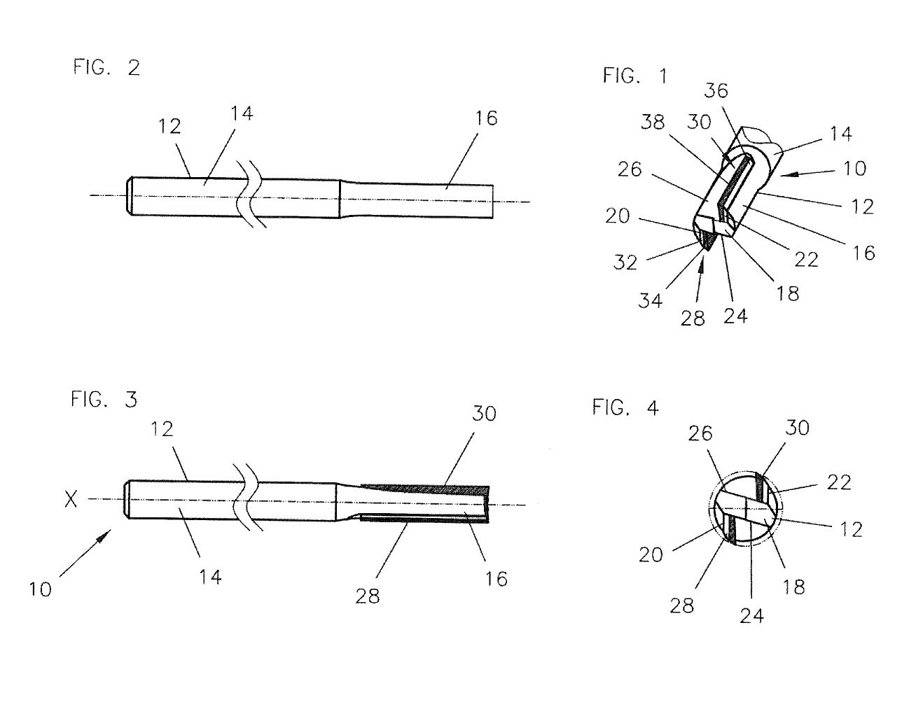

A composite bit 10 is illustrated in FIGS. 1-4. The composite bit 10 includes a bit body 12. The bit body 12 can be of any suitable length and, for example, is a first metal such as Hot Work Tool Steel (H). There are a variety of suitable Hot Work Tool Steels, such as the Chromium and Tungsten varieties. One such steel is H13 although other varieties of steel could be used. The bit body 12 has a shank end 14 that is received by a drill or router and a bit end 16 that performs cutting when the composite bit 10 is rotated by the drill or router.

As can be seen in FIGS. 1 and 4, the bit end 16 of the bit body 12 has a tip 18 that is generally Z shaped forming first and second inwardly directed faces 20 and 22 and first and second outwardly directed faces 24 and 26. The planes of the first and second inwardly directed faces 20 and 22 are generally parallel to one another, and the planes of the first and second outwardly directed faces 24 and 26 are generally parallel to one another. The first inwardly directed face 20 and the first outwardly directed face 24 form an acute angle such as 75°, and the second inwardly directed face 22 and the second outwardly directed face 26 similarly form an acute angle such as 75°. The first and second inwardly directed faces 20 and 22 extend a suitable distance along a longitudinal axis X from the tip 18 and into the bit end 16 away from the tip 18 as shown in FIG. 1. The tip 18 could be a centering tip, as desired.

Although the first and second inwardly directed faces 20 and 22 are shown as planar faces, the first and second inwardly directed faces 20 and 22 could be curved faces or other geometrically shaped faces. Similarly, although the first and second outwardly directed faces 24 and 26 are shown as planar faces, the first and second outwardly directed faces 24 and 26 could be curved faces or other geometrically shaped faces.

A first cushion core 28 is suitably affixed such as by brazing to the first inwardly directed face 20 as shown in FIGS. 1 and 4, and a second cushion core 30 is suitably affixed such as by brazing to the second inwardly directed face 22 as also shown in FIGS. 1 and 4. As shown in FIG. 4, the first cushion core 28 extends radially beyond the first inwardly directed face 20 by a desired amount, and the second cushion core 30 extends radially beyond the second inwardly directed face 22 by a desired amount.

As shown in FIG. 1, the first cushion core 28 comprises a first shim 32 and a first cutting edge 34, and the second cushion core 30 comprises a second shim 36 and a second cutting edge 38.

The first cutting edge 34 may be formed from a second metal such as hard carbide that is typically harder than normal carbide which has been used in bits. For example, normal carbide used in bits has a hardness of 1500 (based on HV30 values), whereas the carbide chosen for the first cutting edge 34 may have a hardness of greater than 1800 (based on HV30 values). As a further example, the carbide chosen for the first cutting edge 34 may have a hardness of around 2000 (based on HV30 values). Such carbide, for example, may be HB20UF grade carbide and may be supplied by LMT Boehlerit.

Other carbide manufacturers who make a grade of carbide with similar hardness, cobalt content and grain size could be selected.

Therefore, the first cutting edge 34 employs a harder grade carbide than is normally used, the first cutting edge 34 has a longer life than normal carbide cutting edges, the first cutting edge 34 exhibits more abrasion resistance than normal carbide cutting edges, and the first cutting edge 34 resists edge wear better than normal carbide cutting edges.

However, the use of a harder material for the first cutting edge 34 means that the first cutting edge 34 can be more fragile that the normal material used in bits. Indeed, if the first cutting edge 34 were brazed directly to the bit body 12 similar to the manner in which all other cutting edges are brazed to bit bodies, the impact forces on the first cutting edge 34 during normal use would cause micro-cracks in the first cutting edge 34 resulting in its premature failure.

Therefore, the first shim 32 is used to affix the first cutting edge 34 to the bit body 12 so as to cushion the first cutting edge 34. The material of the first shim 32 is chosen so that the first shim 32 absorbs thermal expansion and/or impact shocks to eliminate or materially reduce fracturing of the first cutting edge 34. The material of the first shim 32 might also be a conveniently selected alloy that can be used to braze the first cutting edge 34 to the bit body 12. For example, the material of the first shim 32 can be a third metal such as Plymetal #5031.

Plymetal #5031 may be supplied by Bellman Melcor, Inc. of Tinley Park, Ill. 60477. Plymetal #5031 comprises copper sandwiched between brazing alloys such as 50% silver with other alloying agents including nickel, copper, and/or zinc. Copper is sufficiently soft, such as F40 Rockwell hardness, and has a high enough melting point, such as 1900° F., that it will not fail in the intended application. Other materials could be used provided that they are sufficiently soft and durable to act as the shims 36 and 20.

The material of the second shim 36 can be similar to or the same as the material of the first shim 32. Also, the material of the second cutting edge 38 can be similar to or the same as the material of the first cutting edge 34.

Accordingly, the first and second shims 32 and 36 permit the use of the harder materials for the first and second cutting edges 34 and 38 than is otherwise the case. The harder material for the first and second cutting edges 34 and 38 allows the first and second cutting edges 34 and 38 to cut through more abrasive materials than existing cutting edges.

The description herein is to be construed as illustrative only. The details may be varied substantially without departing from the spirit of the invention as defined by the claims below, and the exclusive use of all modifications which are within the scope of these claims is reserved.

We claim:

1. A bit comprising:
a body having a shank end and a cutting end, wherein the shank end is arranged to be held by a drill or router;
a cutting edge at the cutting end of the body; and,
a shim between the cutting end of the body and the cutting edge, wherein the shim is arranged to absorb forces so as to protect the cutting edge.

2. The bit of claim 1 wherein the shim comprises a brazing material that is arranged to braze the cutting edge to the cutting end.

3. The bit of claim 1 wherein the body comprises high speed steel, wherein the cutting edge comprises a carbide having a hardness of at least 1800 based on HV30 values, and wherein the shim comprises a brazing material.

4. The bit of claim 1 wherein the cutting edge comprises a carbide having a hardness of at least 1800 based on HV30 values, and wherein the shim comprises a brazing material.

5. The bit of claim 1 wherein the cutting edge comprises a carbide having a hardness of at least 1800 based on HV30 values.

6. The bit of claim 1 wherein the body comprises high speed steel, wherein the cutting edge comprises a carbide having a hardness of around 2000 based on HV30 values, and wherein the shim comprises a brazing material.

7. The bit of claim 1 wherein the cutting edge comprises a carbide having a hardness of around 2000 based on HV30 values, and wherein the shim comprises a brazing material.

8. The bit of claim 1 wherein the cutting edge comprises a carbide having a hardness of around 2000 based on HV30 values.

9. The bit of claim 1 wherein the body comprises a first metal, wherein the cutting edge comprises a second metal having a hardness of at least 1800 based on HV30 values, wherein the shim comprises a third metal, wherein the third metal comprises a brazing metal, and wherein the first, second, and third metals are all different metals.

10. The bit of claim 1 wherein the cutting edge comprises a first metal having a hardness of at least 1800 based on HV30 values, wherein the shim comprises a second metal, wherein the second metal comprises a brazing metal, and wherein the first and second metals are all different metals.

11. The bit of claim 1 wherein the cutting edge comprises a metal having a hardness of at least 1800 based on HV30 values.

12. The bit of claim 1 wherein the body comprises a first metal, wherein the cutting edge comprises a second metal having a hardness of around 2000 based on HV30 values, wherein the shim comprises a third metal, wherein the third metal comprises a brazing metal, and wherein the first, second, and third metals are all different metals.

13. The bit of claim 1 wherein the cutting edge comprises a first metal having a hardness of around 2000 based on HV30 values, wherein the shim comprises a second metal, wherein the second metal comprises a brazing metal, and wherein the first and second metals are all different metals.

14. The bit of claim 1 wherein the cutting edge comprises a metal having a hardness of around 2000 based on HV30 values.

15. A bit comprising:
a high speed steel body having a shank end and a cutting end, wherein the shank end is arranged to be held by a drill or router; and,
a carbide cutting edge at the cutting end of the high speed steel body, wherein the carbide cutting edge has a hardness greater than 1800 based on HV30 values, wherein the carbide cutting edge is brazed to the cutting end of the high speed steel body by a brazing shim, and wherein the brazing shim is arranged to absorb forces so as to protect the carbide cutting edge.

16. The bit of claim 15 wherein the carbide cutting edge has a hardness of around 2000 based on HV30 values.

17. A bit comprising:
a high speed steel body having a shank end and a cutting end, wherein the shank end is arranged to be held by a drill or router, and wherein the cutting end comprises first and second faces;
a first carbide cutting edge at the cutting end of the high speed steel body, wherein the first carbide cutting edge has a hardness greater than 1800 based on HV30 values, wherein the first carbide cutting edge is brazed to the first face of the cutting end of the high speed steel body by a first brazing shim, and wherein the first brazing shim is arranged to absorb forces so as to protect the first carbide cutting edge; and,
a second carbide cutting edge at the cutting end of the high speed steel body, wherein the second carbide cutting edge has a hardness greater than 1800 based on HV30 values, wherein the second carbide cutting edge is brazed to the second face of the cutting end of the high speed steel body by a second brazing shim, and wherein the second brazing shim is arranged to absorb forces so as to protect the second carbide cutting edge.

18. The bit of claim 17 wherein the first carbide cutting edge has a hardness of around 2000 based on HV30 values, and wherein the second carbide cutting edge has a hardness of around 2000 based on HV30 values.
